(19) United States
(12) Patent Application Publication
(10) Pub. No.: US 2025/0124222 A1
(43) Pub. Date: Apr. 17, 2025

(54) INTERNET OF MODELS (IOMs)

(71) Applicant: Cytomate Solutions and Services, Doha (QA)

(72) Inventors: Masoom Alam Muhammad, Doha (QA); Hamad Saleh Hadeed, Doha (QA); Mehar un Nisa Izhar, Islamabad (PK); Tehniyat Saif, Rawalpindi (PK); Qummar un Nisa, Neelum (PK)

(21) Appl. No.: 18/484,664

(22) Filed: Oct. 11, 2023

(51) Int. Cl. G06F 40/20

(52) U.S. Cl. CPC G06F 40/20

(57) ABSTRACT

Internet of Models (IoMs) is the interconnected communication between different models, transcending organizational boundaries. IoMs act as an organizational savant, possessing an encyclopedic knowledge of all activities within the organization, bridging communication gaps among departments, and even conversing with external LLMs. The external model acts as a liaison, facilitating collaboration beyond the organization. Specialized Models dedicated to distinct software domains streamline data integration, collecting outputs from various systems. A model, such as a Large Language Model (LLM), is a sophisticated AI system capable of understanding and generating human-like text based on the input it receives. IoM can handle a variety of inputs and can also perform real-time analysis. IoM offers centralized and decentralized approaches, both empowering models to execute actions seamlessly, facilitating a new era of AI-driven possibilities in organizational operations, communication, and collaboration.

### BACKGROUND

The disclosed embodiments relate to a communication system of artificial intelligence models.

Large language models have emerged as a breakthrough technology in the field of natural language processing. By utilizing deep learning techniques on vast datasets, LLMs have achieved human-level abilities in tasks like question-answering, translation, and conversation modeling. As a result, LLMs are increasingly powering innovative applications across many domains. In the area of dialog systems, LLMs are enabling more human-like interactions for automated assistants by understanding context, generating responses at scale, and simulating different personalities. For businesses, LLMs are enhancing analytics platforms and powering new intelligent bots. As LLM capabilities continue advancing, we may expect them to proliferate into even more applications involving language over the coming years.

US20230275956A1 explores the uses of LLMs and describes a method for leveraging the generative capabilities of LLMs to create lightweight information models for Internet of Things devices. The LLM can analyze sensor data and automatically generate a standardized vocabulary to help devices from different manufacturers communicate with each other.

US20230112921A1 dives deeper into natural language interactions enabled by LLMs. It discloses a system that can chain multiple LLMs together to handle more complex human-AI dialog. For example, an initial LLM may classify a user's intent while subsequent LLMs refine the response in the context of previous exchanges.

Focusing specifically on conversational assistants, US20230074406A1 examines how LLMs can be employed to generate response options. It outlines techniques such as feeding assistant responses into an LLM along with context data to modify and expand the answers before selecting one to present.

Moving beyond language, US20210192412A1 shows LLMs integrating with other AI components. It describes an overall framework using LLM outputs to aid business intelligence applications involving tasks like predictive analytics and decision-making.

The above information disclosed in this background section is only for enhancement of understanding of the background of the inventive concept, and, therefore, it may contain information that does not form the prior art that is already known in this country to a person of ordinary skill in the art.

### SUMMARY

A system of Large Language Models (LLMs), the internet of models (IoMs) comprising internal LLMs and external LLMs, located within an organization or multiple organizations, wherein the LLMs are configured to carry out intra-organization or inter-organization communication by a method comprising, utilizing Large Language Models (LLMs) for enabling real-time awareness, and continuous monitoring, action-taking, and cross-department collaboration by coordinating tasks and sharing insights among the models; wherein the internet of models (IoMs) comprises a network of interconnected LLMs; and wherein there are domain specific LLMs specially designed for processing software output and performing desired tasks within the organization. The real-time awareness is carried out by continuous feeding of outputs, from all software of the system, to LLMs to keep them updated about all activities within the system.

The Internet of Models (IoMs) is a system where interconnected Models, including Large Language Models (LLMs), collaborate both within and outside organizations to enhance efficiency, productivity, and communication. IoMs offer central and decentralized approaches, each suited for different organizational needs. It enables real-time data analysis, cross-department collaboration, and inter-organizational coordination. Within organizations, specialized LLMs tailored to distinct domains facilitate data integration. Challenges and mitigation strategies for IoM implementation are discussed, emphasizing the importance of fine-tuning, data integration, and interoperability.

### BRIEF DESCRIPTION OF THE DRAWINGS

The accompanying drawings, which are included to provide a further understanding of the inventive concepts and are incorporated in and constitute a part of this specification, illustrate exemplary embodiments of the inventive concepts, and, together with the description, explain the principles of the inventive concepts.

FIG. 1 illustrates a proposed system diagram.

FIG. 2 illustrates the Internal LLM characteristics.

FIG. 3 illustrates the Internal LLM processing software output.

FIG. 4 illustrates one domain-specific internal LLM interaction with software, external LLM, and users.

FIG. 5 illustrates the overall concept of Internet of Models (IOM).

### DESCRIPTION OF THE INVENTION

In the following description, for the purposes of explanation, numerous specific details are set forth to provide a thorough understanding of various exemplary embodiments. It is apparent, however, that various exemplary embodiments may be practiced without these specific details or with one or more equivalent arrangements.

In the accompanying figures, the size and relative sizes of elements may be exaggerated for clarity and descriptive purposes. Also, like reference numerals denote like elements.

The terminology used herein is for the purpose of describing embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Large Language Models (LLMs) represent a transformative force in the realm of artificial intelligence. These models, trained on vast troves of text data, have evolved to comprehend, and generate human language with remarkable accuracy and fluency. LLMs find applications in simplifying communication between humans and machines, from virtual assistants to chatbots, and excel in processing complex language tasks like translation, sentiment analysis, and code generation. Their versatility extends beyond language, enabling them to analyze data, create content, and more. LLMs hold the potential to reshape organizational operations by automating tasks, aiding in decision-making, enhancing customer engagement, bolstering data security, and crafting customized content, ushering in a future where these models are seamlessly integrated into the fabric of businesses and everyday life.

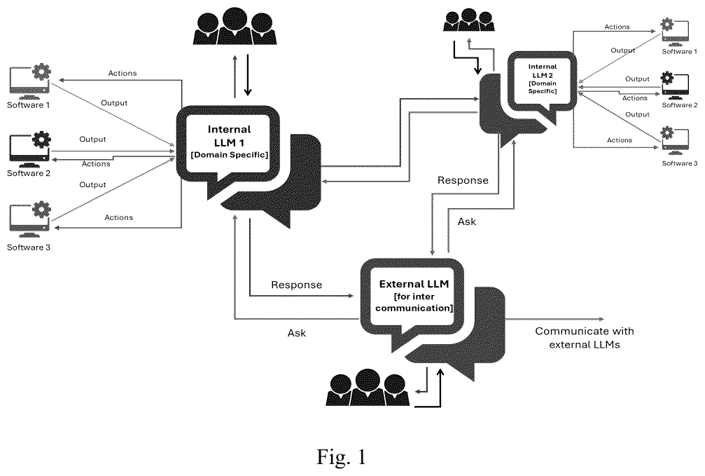

In the evolving landscape of artificial Intelligence, the present invention discloses a mechanism of communication among LLMs, hereinafter called as Internet of Models (IoMs) as shown in FIG. 1. In the Internet of Models (IoMs), a model is a Large Language Model (LLM). The AI models transcend their individual functions to become interconnected entities that communicate with one another. IoM is an embodiment of the models collaborating both within and outside organizations. At its core, IoM represents a dynamic ecosystem where models act as knowledgeable managers, each possessing an intricate understanding of their respective domains and a willingness to facilitate seamless communication.

IoM thrives on the ability of LLMs to analyze, correlate, communicate, and execute actions. It is not merely about data exchange; it is about harnessing the collective intelligence of these LLMs to enhance organizational efficiency. IoM enables LLMs to interpret vast volumes of data, making sense of intricate patterns and nuances. It fosters collaboration, bridging the knowledge gaps that often exist within and between organizations. It empowers organizations to enhance productivity, optimize decision-making, and bolster security. In IoMs, the LLMs may seamlessly coordinate tasks across different departments, provide real-time insights for executives, and even engage in collective problem-solving with external partners. Whether it is streamlining internal communication or orchestrating inter-organizational endeavors, IoM may act as a catalyst for a digital evolution.

Internet of Models (IoMs) is a system of Large Language Models (LLMs) comprising internal LLMs and external LLMs. These LLMs may be located within one organization or in multiple organizations wherein they are configured to carry out intra-organization communication with the LLMs of the same organization or inter-organization communication with the LLMs of the other organizations. The said communication is carried out by a method comprising utilizing Large Language Models (LLMs) for enabling real-time awareness; and continuous monitoring, action-taking, and cross-department collaboration by coordinating tasks and sharing insights among the models. The internet of models (IoMs) comprises a network of interconnected LLMs wherein there are domain specific LLMs specially designed for processing software output and performing desired tasks within the organization.

The real-time awareness is carried out by continuous feeding of outputs, from all software of the system, to LLMs to keep them updated about all activities within the system. The cross-department collaboration takes place by coordinating inter-departmental activities and various other tasks that extend beyond the organization's boundaries.

The communication among LLMs of multiple organizations takes place through a dedicated LLM in each organization acting as an external LLM, and wherein the external LLM of each organization is provided with limited information to be communicated with the external LLMs of the other organizations, to act as a security barrier.

The LLMs are customized for, communication with other LLMs and users, and, processing software outputs and domain specific knowledge to perform the tasks. All the internal LLMs are configured to interface and converse with each other, request information or actions from LLMs, and serve as a liaison for intra-organizational tasks. IoMs provides instant responses to inquiries in natural language and performs specialized tasks of an organization with the use of customized domain specific LLMs specially designed for performing these tasks. It assists employees in optimizing workflow, simplifies document management by analyzing documents, gathers and analyzes information, performs complex organizational tasks, facilitates collaborative problem-solving, enables user reporting, automates various processes, and operates with a fundamental element of transparency.

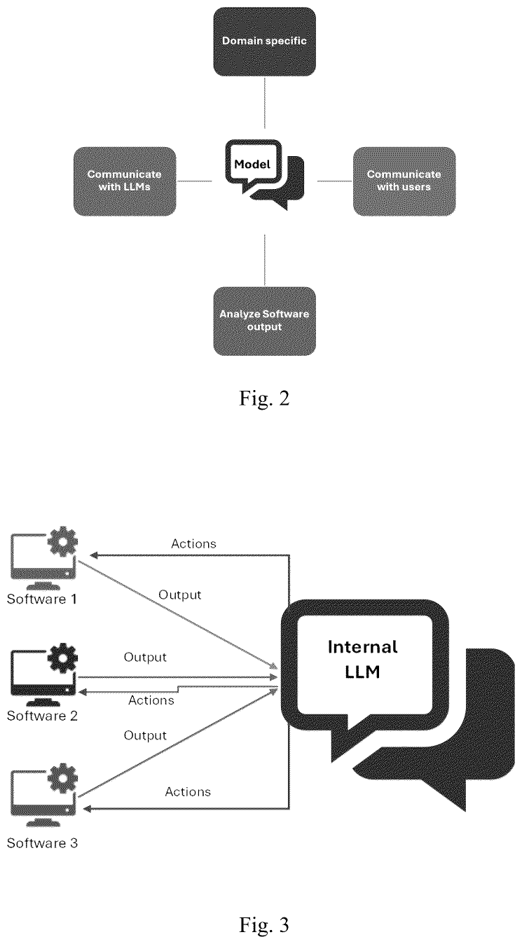

In an embodiment, consider an internal model as a digital manager with a profound understanding of an organization's every nook and cranny as shown in FIG. 2. This model may possess a comprehensive overview of all activities transpiring within the organization. It excels at bridging communication gaps among diverse departments, ensuring that information flows effortlessly. Furthermore, it can engage in a dialogue with other managers within different departments, facilitating cross-functional collaboration.

Now, consider the External model as the manager who steps outside the organization when necessary. This model serves as the liaison between this organization and the others. Its role extends beyond the organization's boundaries like scheduling meetings, booking flights, fostering collaboration between organizations and other related tasks. It is the communicator, the orchestrator, connecting your organization with the wider world.

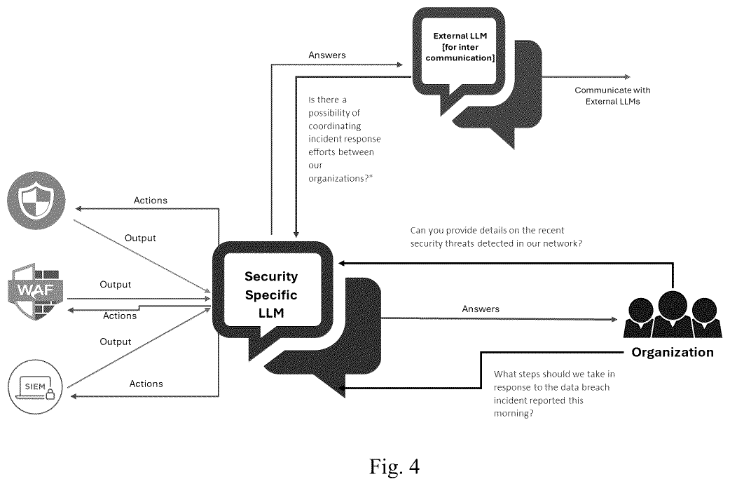

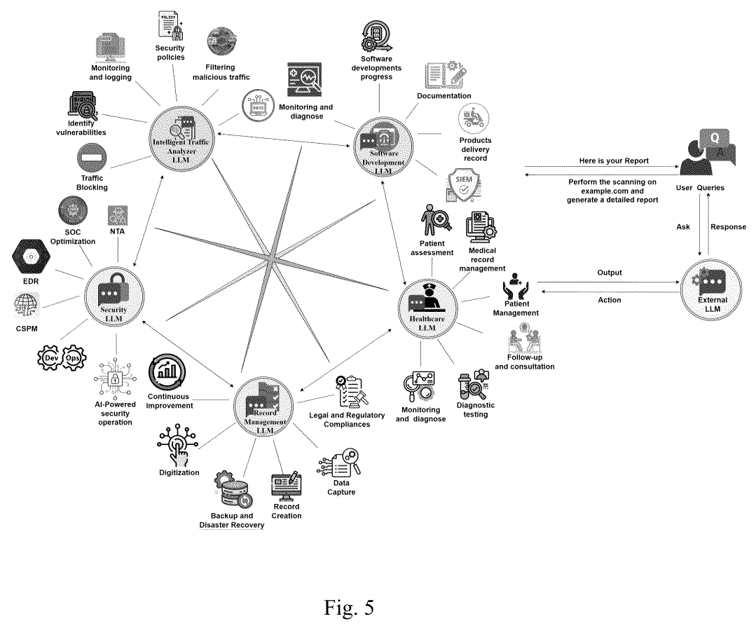

Within the organization, Internal IoM may be considered as a collective of specialized LLMs tailored to distinct software domains as shown in FIG. 3. The core function here is to gather data from various software systems, whether in the form of logs, real-time system outputs, or APIs (Application Programming Interface).

For example, there may be a model dedicated to Security Information and Event Management (SIEM) software as shown in FIG. 4. This specialized model not only comprehends the intricacies of SIEM but also operates it.

Another example is the e-commerce giant handling a multitude of customer inquiries daily. Here, IoM may step in as a significant change. Internal LLMs possess in-depth knowledge of the company's products and services, swiftly accessing information on orders, products, and customer preferences. External LLMs, on the other hand, engage with customers in natural language, addressing queries, tracking orders, and managing service appointments. Specialized LLMs focus on specific tasks like inventory management and coordination. With a central approach, data flows seamlessly, allowing for real-time reporting and operational optimization. Meanwhile, domain specific LLMs handle specialized tasks such as customer inquiries on the website and secure payment processing. All LLMs can execute actions, like initiating refunds through APIs. This IoM implementation streamlines customer support, optimizes operations, and elevates customer satisfaction, highlighting IoM's transformative power beyond security in modern business operations.

### Centralized and Decentralized Approach

IoM offers two fundamental approaches. The first is a central approach, where a single general purpose LLM serves as the hub, collecting data from all software systems. This central LLM acts as an information nexus, reporting to relevant individuals, performing tasks, and interacting with other LLMs. This approach requires the central LLM to be finely tuned for multiple roles, from conversing with external LLM to engaging openly with internal teams, and meticulously analyzing and processing software outputs This approach is well-suited for organizations that possess data and tasks that can be effectively addressed using a single general-purpose model. The second approach is distributed, consisting of multiple, domain specific LLMs. These specialized models focus on specific areas, like security software. They receive data only from relevant systems, such as Web Application Firewalls (WAF) and SIEM and can communicate with other LLMs within the organization when needed. This approach enhances efficiency by delegating expertise to specialized models. This approach is highly suitable for organizations dealing with complex data and specialized tasks that require domain-specific knowledge and cannot be effectively accomplished using a single general-purpose LLM. In both approaches, the presence of an external model is a common factor. In both scenarios, there will be an external model specifically designed to handle cross-organization tasks.

A noteworthy feature of IoM is that all LLMs can execute actions. For instance, if a user requests an LLM to edit an Excel sheet and add specific data, this can be seamlessly achieved through APIs.

The IoM is a world where interconnected LLMs reshape how organizations function, communicate, and collaborate. It may be a journey into the future of AI, where knowledge, communication, and action converge to redefine the digital landscape.

### Methodology

Large Language Models (LLMs) are deep learning models trained on vast amounts of text using self-supervised techniques. Through a process called pre-training, they learn robust language representations which can then be fine-tuned for specific tasks. Fine-tuning involves further training a LLM on a smaller labeled dataset for the target domain through back-propagation. This allows leveraging pre-trained knowledge while specializing in models for new use cases. Several open-source LLMs have been pre-trained on massive publicly available text corpora. These models may be utilized for developing IoM by fine-tuning domain-specific variants.

Fine-tuning a single central LLM for multiple internal/external communication and coordination tasks could prove challenging due to conflicting objectives and security concerns. Domain fragmentation leads to better specialization. Distributed domain specific LLMs ensure each LLM focuses on a dedicated function like security monitoring, analysing, etc. However, an LLM for inter-organizational coordination may require understanding of diverse external domains.

To implement this, there involves fine-tuning of a separate LLM focused only on liaising skills. All LLMs are fed comprehensive organizational data through APIs, logs, and reports from existing software systems in standardized formats like JSON. This provides the required contextual knowledge. Central and distributed architectures are conceptualized, and their relative pros/cons assessed based on factors like scalability, data privacy, and failure resilience during the implementation planning phase.

Extensive pilot implementations, iterations, and user evaluations will help validate the efficacy of the proposed IoM model and identify opportunities for enhancement. This invention lays the groundwork for streamlining modern organizational operations through interconnected AI.

Understanding Large Language Models (LLMs): To embark on the implementation of the Internet of Models (IOM), it is imperative to comprehensively understand LLMs. LLMs are neural network-based models that have been pre-trained on vast corpora of text data. They possess the ability to understand and generate human-like text based on patterns learned during training. Fine-tuning, a process that adapts pre-trained models to specific tasks, is a crucial aspect. For our IoM implementation, fine-tuning will be pivotal to customizing LLMs to the nuances of organizational operations, processing software outputs, and communication.

Leveraging Open-Source LLMs: It involves exploration of existing open-source LLMs as a foundation for our IoM ecosystem. These readily available models offer a starting point for fine-tuning. The advantage of open-source LLMs lies in their versatility and adaptability, making them a viable choice for customizing IoM to our organization's needs.

Model-to-Model communication: Communicating between Language Models (LLMs) presents a unique challenge, as these models are primarily designed for interacting with humans. Fine-tuning LLMs for inter-LLM communication is distinct from their traditional use. Unlike human communication, LLM-to-LLM interaction lacks the nuances of human language, such as emotion and context awareness. Therefore, adapting LLMs to effectively converse with other LLMs requires careful consideration of data, training techniques, and protocols to ensure coherent and meaningful exchanges within the AI ecosystem. This specialized fine-tuning helps bridge the gap between AI systems, enabling them to collaborate efficiently and expand their capabilities beyond individual tasks.

Central Approach Challenges: In the central IoM approach, one LLM is tasked with multiple roles, including inter-LLM communication, interaction with external LLM, and analyzing diverse software outputs. It's ideal for a small organization or an organization doing only general and simple tasks. Challenges include:
Fine-Tuning Complexity: Fine-tuning a single LLM for these multifaceted tasks requires careful consideration of training data, avoiding over-fitting, and maintaining model performance.
Interoperability: Ensuring that this central LLM effectively communicates with diverse software systems, processes logs, APIs, and reports, poses interoperability challenges.
Security Concerns: Concentrating all data and tasks in one central LLM can pose significant security risks. If this central LLM were to be compromised or manipulated by users, it could lead to the exposure of sensitive information or unauthorized access to various data sources.

Decentralized Approach: In the decentralized IoM approach, each LLM focuses on a specific domain, such as security or communication. This approach is suitable for large organizations or an organization performing specialized services that need domain knowledge about the tasks. It also addressed security concerns by giving each LLM only the data needed for specific tasks. Challenges and considerations include:
Fine-Tuning for Domain Expertise: Fine-tuning domain specific LLMs to excel in their designated areas requires curated training datasets and a deep understanding of the domain's intricacies.
Finetuning for LLM-to-LLM Communication: Fine-tuning for LLM-to-LLM communication involves fine-tuning the pretrained model using an LLM-to-LLM dataset. Since such a dataset is not readily available, it is necessary to create one for the fine-tuning process.
Finetuning for software output processing: An Internal LLM needs to be finetuned for processing its relevant software outputs to effectively enhance the analyzation process.

Data Integration and Feeding LLMs: Central to IoM's success is the comprehensive feeding of information from all organizational software systems. This includes logs, real-time system outputs, APIs, reports, and other formats. Challenges involve:
Data Format Standardization: Defining a standardized format for data from disparate systems to ensure that LLMs can effectively process and correlate information.
Real-Time Data Integration: Implementing mechanisms for real-time data integration, enabling LLMs to respond promptly to emerging events.
Security and Privacy: Ensuring that sensitive data is handled securely and in compliance with relevant regulations.

Implementation Plan: Proposing an implementation plan for each aspect, including:
LLM Selection: Identifying suitable open-source LLMs for fine-tuning.
Fine-Tuning Strategies: Defining strategies for fine-tuning LLMs for various roles, including external and internal domain specific LLMs.
Data Integration Framework: Designing a framework for collecting and processing data from different software systems.
Interoperability Solutions: Investigating methods for seamless communication between LLMs and software systems.

Challenges and Mitigations: Highlighting the challenges inherent in each aspect of IoM implementation and proposing mitigation strategies to address them effectively.

By meticulously addressing these aspects, from understanding LLMs and fine-tuning to data integration and implementation planning, we lay the foundation for a robust Internet of Models tailored to revolutionize our organization's operations, and communication.

### Applications of IoMs:

Real-Time Data Access and Decision-Making: IoM empowers executives and decision-makers with real-time data access and insights. They can ask IoM for the latest sales figures, market trends, or financial data in plain language and receive immediate, data-driven responses. This transforms decision-making processes, making them more agile and informed.

Enhanced Cyber security Vigilance: IoM acts as an AI-based Security Operations Center (SOC). It continuously monitors security logs and alerts from various systems, identifies potential threats, and takes immediate actions or recommends responses. This proactive approach strengthens an organization's cyber security posture, reducing the risk of data breaches.

Cross-Department Collaboration: IoM bridges communication gaps between departments. It enables seamless collaboration by coordinating tasks, sharing insights, and facilitating cross-functional projects. This transformation leads to enhanced teamwork, faster project execution, and better innovation.

Inter-Organizational Coordination: IoM extends its capabilities to coordinate with external LLMs of partner organizations. It simplifies tasks like scheduling joint meetings, sharing project updates, or even negotiating contracts. This not only fosters better collaboration but also streamlines inter-organizational processes.

Employee Productivity Enhancement: IoM assists employees in optimizing their workflow. It offers personalized productivity suggestions, helps with task prioritization, and automates routine administrative duties. This transformation enhances individual and collective productivity across the organization.

Streamlined Document Management: IoM simplifies document management. Employees can request IoM to locate, update, or analyze documents with specific criteria. This eliminates the need for manual document sorting, saving time and reducing errors.

Customer Support and Engagement: IoM improves customer support by providing instant responses to customer inquiries, resolving common issues, and offering personalized recommendations. This enhances customer satisfaction and loyalty while reducing response times.

Compliance and Risk Management: IoM ensures compliance with industry regulations by continuously monitoring and analyzing data for potential compliance violations. It assists in risk assessment, compliance reporting, and timely corrective actions.

Scalable Operations: IoM's distributed approach enables organizations to scale operations efficiently. They can deploy domain-specific LLMs for various software systems and processes. This scalability ensures that as the organization grows, its AI capabilities can seamlessly expand to accommodate new demands.

Market and Competitive Intelligence: IoM gathers and analyzes information about market trends, competitor activities, and consumer sentiment from various sources. It provides organizations with valuable insights for strategic planning, product development, and staying ahead in the market.

These use cases highlight the profound transformation that IoM may bring to organizations. It simplifies complex tasks, enhances communication and collaboration, fortifies cyber-security, and empowers decision-makers with real-time data. IoM's potential to improve productivity, streamline operations, and facilitate inter-organizational cooperation makes it a formidable asset in the modern digital landscape.

What is claimed is:

1. A system of Large Language Models (LLMs), the internet of models (IoMs) comprising internal LLMs and external LLMs, located within an organization or multiple organizations, wherein the LLMs are configured to carry out intra-organization or inter-organization communication by a method comprising:
utilizing Large Language Models (LLMs) for enabling real-time awareness; and
continuous monitoring, action-taking, and cross-department collaboration by coordinating tasks and sharing insights among the models;
wherein the internet of models (IoMs) comprises a network of interconnected LLMs;
wherein there are domain specific LLMs specially designed for processing software output and performing desired tasks within the organization.

2. The system of claim 1, wherein the real-time awareness is carried out by continuous feeding of outputs, from all software of the system, to LLMs to keep them updated about all activities within the system.

3. The system of claim 1, wherein the cross-department collaboration comprises coordinating inter-departmental activities and various other tasks that extend beyond the organization's boundaries.

4. The system of claim 1, wherein the communication among LLMs of multiple organizations takes place through a dedicated LLM in each organization acting as an external LLM, and wherein the external LLM of each organization is provided with limited information to be communicated with the external LLMs of the other organizations, to act as a security barrier.

5. The system of claim 4, wherein the LLMs are customized for, communication with other LLMs and users, and, processing software outputs and domain specific knowledge to perform the tasks.

6. The system of claim 5, wherein all the internal LLMs are configured to interface and converse with each other, request information or actions from LLMs, and serve as a liaison for intra-organizational tasks.

7. The system of claim 6, which provides instant responses to inquiries in natural language.

8. The system of claim 6, which performs specialized tasks of an organization with the use of customized domain specific LLMs specially designed for performing these tasks.

9. The system of claim 6, which assists employees in optimizing workflow, simplifies document management by analyzing documents, gathers and analyzes information, performs complex organizational tasks, facilitates collaborative problem-solving, enables user reporting, automates various processes, and operates with a fundamental element of transparency.
